(19) United States
(12) Patent Application Publication
(10) Pub. No.: US 2016/0179911 A1
(43) Pub. Date: Jun. 23, 2016

(54) ASYNCHRONOUS INTERACTION IN THE REPORT GENERATOR

(71) Applicant: salesforce.com, inc., San Francisco, CA (US)

(72) Inventors: Thomas Joseph Tobin, San Francisco, CA (US); Vladislav Eroshin, Menlo Park, CA (US); Jeremiah Chi Seng Lu, Union City, CA (US)

(21) Appl. No.: 15/052,232

(22) Filed: Feb. 24, 2016

Related U.S. Application Data
(63) Continuation of application No. 13/276,187, filed on Oct. 18, 2011.
(60) Provisional application No. 61/503,747, filed on Jul. 1, 2011.

(51) Int. Cl. G06F 17/30; G06F 3/0484

(52) U.S. Cl. CPC G06F 17/30554; G06F 3/0484

(57) ABSTRACT

Methods and systems are provided for a user system to interact asynchronously with the report generator when an operation is performed on a report in the report generator. The report generator relinquishes control to the user system to perform other operations while the report generator fetches data from the multi-tenant database necessary for the operation.

### CLAIM OF PRIORITY

This application claims the benefit of U.S. Provisional Patent Application 61/503,747 entitled, ASYNCHRONOUS INTERACTION IN THE REPORT GENERATOR By Thomas Tobin and Vladislav Eroshin, filed Jul. 1, 2011 (Attorney Docket No. 48-66/650PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to providing asynchronous interaction in the report generator in a multi-tenant database network system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The rapid, secure, ease of use and efficient retrieval of accurate information and subsequent delivery of this information to the user system in a manner that is easy to understand has been and continues to be a goal of administrators of database systems is desirable.

Conventional report generation using report generation tool requires data to be fetched from the database for changes to the report. Fetching data may involve multiple database queries that can be time consuming. The user waits with the screen locked while the data is being fetched. If the amount of data is large, then the wait can be long.

Accordingly, it is desirable to provide techniques to relinquish control to the user system so that the user may perform other operations while the system fetches data for the report generator.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1A shows a block diagram of an embodiment of a system for report generation;

FIG. 1B shows a block diagram of an embodiment of a user system in a system of report generation;

FIG. 2A shows a flowchart of an embodiment of a client-side method of asynchronous interaction with a report generator in a multi-tenant database system;

FIG. 2B shows a flowchart of an embodiment of a queuing method of asynchronous interaction with a report generator in a multi-tenant database system;

FIG. 3 shows a flowchart of an embodiment of a server-side method of asynchronous interaction with a report generator in a multi-tenant database system;

FIG. 4 shows a screenshot of an embodiment of a report creation;

FIG. 5 shows a screenshot of an embodiment of field dragged into the report;

FIG. 6 shows a screenshot of an embodiment of field added to the report;

FIG. 7 shows a block diagram of an embodiment of an environment where in an on-demand database service might be used for methods and systems for asynchronous interaction with report generator;

FIG. 8 shows a block diagram of an embodiment of elements of FIG. 7 and various possible interconnections between elements in an embodiment for methods and systems for asynchronous interaction with a report generator in a multi-tenant database;

FIG. 9 illustrates an embodiment of an environment within which the system for asynchronous interaction with a report generator may operate;

FIG. 10 illustrates embodiment of elements of FIG. 9 and various possible interconnections between elements of the environment.

### DETAILED DESCRIPTION

General Overview

Systems and methods are provided for asynchronous interaction in the report generator, for example, in a multi-tenant database network system. Note that although various implementations are described in the context of a multi-tenant database network system (or multi-tenant database system), these and other implementations may also be utilized in other environments as well, for example, on-demand service environments, LAN systems, WAN systems, database systems, etc.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing asynchronous interaction with a report generator in a multi-tenant database network system will be described with reference to example embodiments.

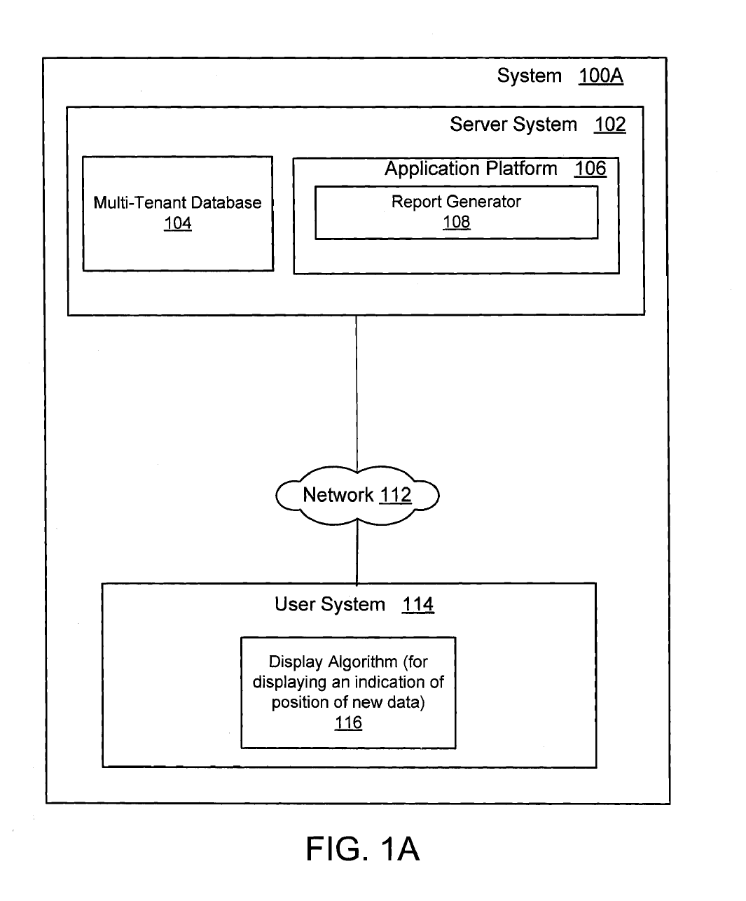

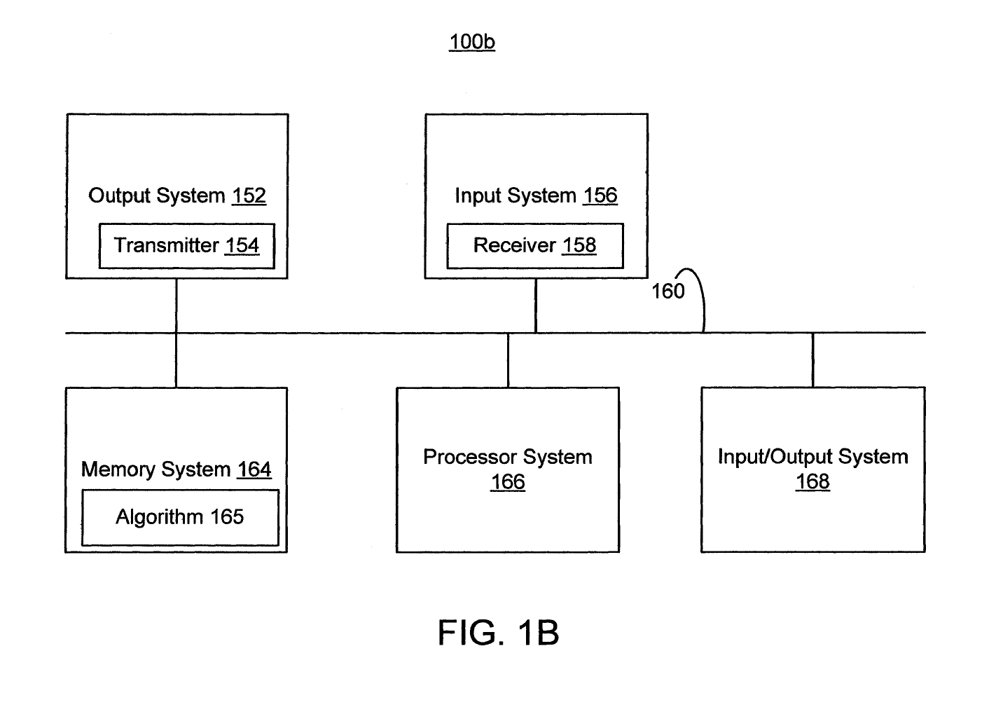

FIG. 1A shows an embodiment of system 100A, system for providing asynchronous interaction in the report generator in an on-demand multi-tenant database system. In an embodiment, system 100A may include server system 102, multi-tenant database 104, application platform 106, report generator 108, network 112, user system 114, and display algorithm 116 (for displaying indication of position of new data), among others. In other embodiments system 100A may not have all of the elements or features listed and/or may have other elements or features instead of or in addition to those listed.

System 100A is a system for providing asynchronous interaction with ‘report generator’ to the tenants of the multi-tenant database system. Report Builder may be an example report generator. The report generator is a tool on system 100A. When a user system requests to perform a function in the report generator, a place holder is displayed to the user system indicating the position of the new data in the report. While the user system proceeds to perform certain other operations on the rest of the report generator webpage, the system fetches the required data for the operation. The report generator and the user system behave asynchronously in the system.

Server system 102 may include multi-tenant database 104 for storing the information required by the tenants of the multi-tenant database and application platform 106. Multi-tenant database 104 may be a database system with multiple tenants that each has a degree of access to at least a portion of the database system that may or may not be the same as the degree of access as other tenants. Each tenant may be an individual or an organization, and each tenant may have representatives, members, employees, customers and/or other entities associated with the tenant, which in turn may also have different degrees of access to the tenant's portion of the database as a result of the tenant's tenancy of the multi-tenant database. The degree of access granted to those associated with the tenant and/or which entities (e.g., representatives, members, employees, customers and/or other entities) are associated with the tenant may be determined by the tenant. The database system may include multiple databases, and each database may be partitioned and/or otherwise shared amongst multiple tenants. Multi-tenant database 104 may have any number of tenants and the tenants may access a portion of the database.

Application platform 106 stores software code for the report generator. Report generator 108 is a report generation and report customization tool in the server system. Report generator 108 provides a summary or tabular reports, manages filters. Report generator 108 may also be used to rearrange groupings and change the date granularity of the report

Report generator 108 receives inputs regarding data for report and the type of report. Report generator 108 fetches data from multi-tenant database and generates reports. When a report requires a new operation, data fields may be dragged and dropped into the data table. In an embodiment, the new operation may include adding and/or removing a column, rearranging groupings and columns, changing the order of data in the report, changing the reporting properties, and/or adding new filtering criteria. Report generator 108 may be available to system administrators and any end-user with report building privilege.

Report generator 108 may be a visual editor for reports. Report generator 108 may enable report creation in real time. In an embodiment, the report generator interface may include three panes, which are Fields, Filters, and Preview. The fields pane may list all accessible fields in the selected report type, which may be organized by folder. A quick find search box and field type filters may enable finding fields, which may then be dragged into the preview pane to add the fields found to the report. The fields pane may be used to create, view, edit and delete custom summary formulas. The filters pane may enable the setting of the view, time frame, and custom filters to limit the data shown in the report. The preview pane may display a dynamic preview that appears during customization of reports to give the user an idea as to how the changes made during the customization affects the layout and/or content of the report. Customizations may include adding, reordering, and/or removing columns, summary fields, formulas, and/or groupings. Customizations may include changing the report format and display options, and/or adding a chart. The preview may show a limited number of records and/or a thumbnail version of the document, which may not include all of the details of the document. To see the complete result, the report needs to be generated.

Report generator 108 may display reports in tabular, summary, or matrix formats. The tabular reports may be the simplest and fastest way to view data. The tabular report may be similar to a spreadsheet, and may consist of an ordered set of fields in columns, with each matching record listed in a row. The tabular report may be an efficient type of report for creating lists of records or a list with a single grand total or other aggregation of the data. Summary reports allow users to group rows of data, view subtotals, and create charts. Summary reports may be used as the source report for dashboard components. An example report in summary format may be a report showing subtotals (and/or other summaries or aggregations of data) based on the value of a particular field or a hierarchical list, such as all opportunities for a team, subtotaled by Stage and Owner. Summary reports with no groupings may be shown as tabular reports. Matrix reports may be similar to summary reports, but may allow grouping and summarizing data by both rows and columns.

Matrix reports may be used for comparing related totals, when the amount of data to summarize is large there are several different fields to compare, or sort data by date and by product, person, or geography. Matrix reports without at least one row and one column grouping show as summary reports on the report run page.

Report generator 108 may generate reports using the data that the tenant has access to, such as the records the tenant owns, records to which the tenant may have read or read/write access, records that may have been shared by other tenants, records owned by or shared with users in roles below in the hierarchy. The report displayed may include fields that are visible to the user system's page layout. In an embodiment, the report displayed may include fields with field-level security settings. In an embodiment, the report may include records of one division or all divisions of the tenant. In another embodiment, the report may include records of all divisions of the tenant.

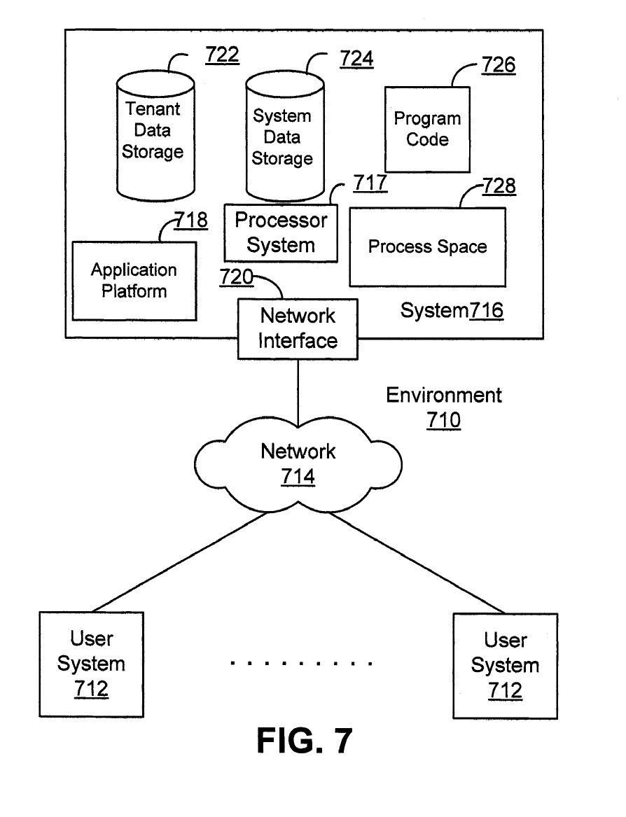

Network 112 (which is further discussed in conjunction with FIG. 7) may be any network or combination of networks of devices that communicate with one another. Server system 102 may interact with user systems via a network using a network interface (which is also further discussed in conjunction with FIG. 7). User system 114 represents one or more user systems which connect to server system 102, via network 112. User systems may be devices with at least one or more processors, a memory system, an input/output system, and a network interface. One or more user systems provide input to server 102.

Display algorithm 116, is an algorithm for displaying an indication of a position of new data. When user system 114 requests an operation in the report, display algorithm 116 displays a place holder in the position where the operation may place the new data and relinquishes the control of the user system to the user to perform other operations. The operations may require accessing multi-tenant database 104. The other operations which the user system may perform may not require the data from the previous operation from report generator 108. New operations that may not be permitted to perform by the user system while the report generator is accessing multi-tenant database to perform the previous operation may include save a report, save the report in another name, run a report, format the report. Display algorithm 116 also replaces the place holder with the actual data received from server system 102. Display algorithm 116 receives data the server system 102 and replaces the place holder with actual received data. Display algorithm 116 tracks how many requests were sent to the server and the last request to the server.

FIG. 1B shows an embodiment of user system 114, a user system for providing asynchronous interactions with report generator in an on-demand database system. In an embodiment, user system 114 may include output system 152, transmitter 154, input system 156, receiver 158, communications system 160, memory system 164, algorithm 165, processor system 166, and input/output device 168. In other embodiments user system 114 may not have all of the elements or features listed and/or may have other elements or features instead of or in addition to those listed.

User system 114 is an example user system, which may be used for providing asynchronous interactions with report generator in a multi-tenant database system. User system 114 may be an internet appliance, such as a laptop, notepad, a tablet computer, iPad, mobile phone, a smart phone or another internet appliance.

Output system 152 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. Transmitter 154 may include a transmitter and/or an antenna for transmitting signals/data to the server system. Input system 156 may include any one of, some of, any combination of, or all of a keyboard system, a touch sensitive screen, a tablet pen, a stylus, a mouse system, a track ball system, a track pad system, buttons on a handheld system, a scanner system, a microphone system, a connection to a sound system, and/or a connection and/or interface system to a computer system, intranet, and/or internet (e.g. IrDA, USB). Receiver 158 may include a receiver and/or an antenna. Communications system 160 communicatively links output system 152, input system 156, memory system 164, processor system 166, and/or input/output system 168 to each other. Communications system 160 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves. Memory system 164 may include, for example, any one of, some of, any combination of, or all of a long term storage system, such as a hard drive; a short term storage system, such as random access memory; a removable storage system, such as a floppy drive or a removable drive; and/or flash memory. Memory system 164 may include one or more machine readable mediums that may store a variety of different types of information. The term machine-readable medium is used to refer to any medium capable carrying information that is readable by a machine. One example of a machine-readable medium is a computer-readable medium. Another example of a machine-readable medium is paper having holes that are detected that trigger different mechanical, electrical, and/or logic responses. Algorithm 165 may store algorithm for interactions with the report generator for receiving the functionality to be performed on the report, displaying a place holder for the new data, relinquishing control of the user system to user, receiving new data from server system 102, and finally replacing the placeholder with the data received. Algorithm 165 may include display algorithm 116.

Processor system 166 may include any one of, some of, any combination of, or all of multiple parallel processors, a single processor, a system of processors having one or more central processors and/or one or more specialized processors dedicated to specific tasks. Also, processor system 166 may include one or more Digital Signal Processors (DSPs) in addition to or in place of one or more Central Processing Units (CPUs) and/or may have one or more digital signal processing programs that run on one or more CPU. Input/output system 168 may include devices that have the dual function as input and output devices. For example, input/output system 168 may include one or more touch sensitive screens, which display an image and therefore are an output device and accept input when the screens are pressed by a finger or stylus, for example. The touch sensitive screen may be sensitive to heat and/or pressure. One or more of the input/output devices may be sensitive to a voltage or current produced by a stylus, for example. Input/output system 168 is optional, and may be used in addition to or in place of output system 152 and/or input device 156.

### Client-Side Method of Providing Asynchronous Interaction in the Report Generator

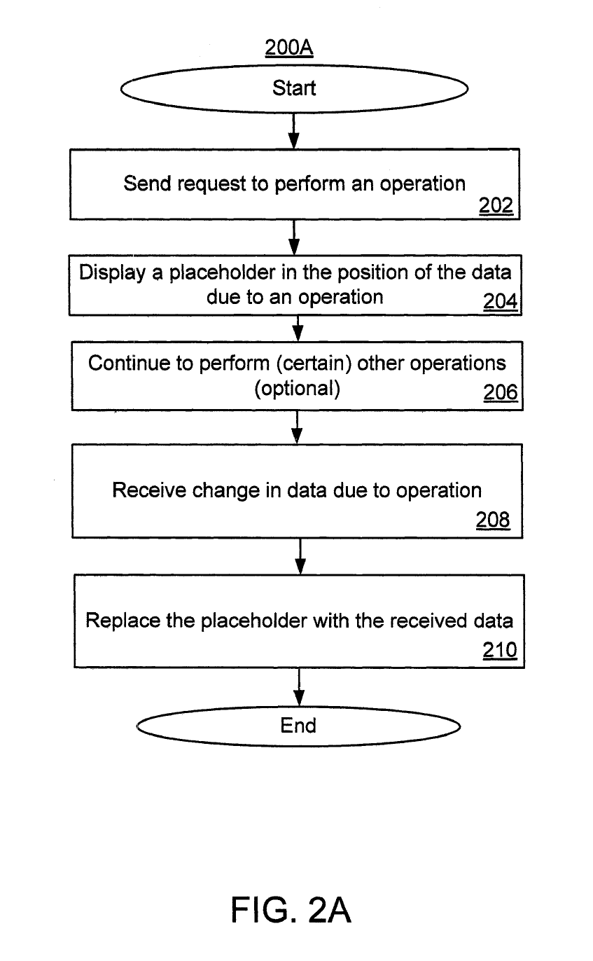

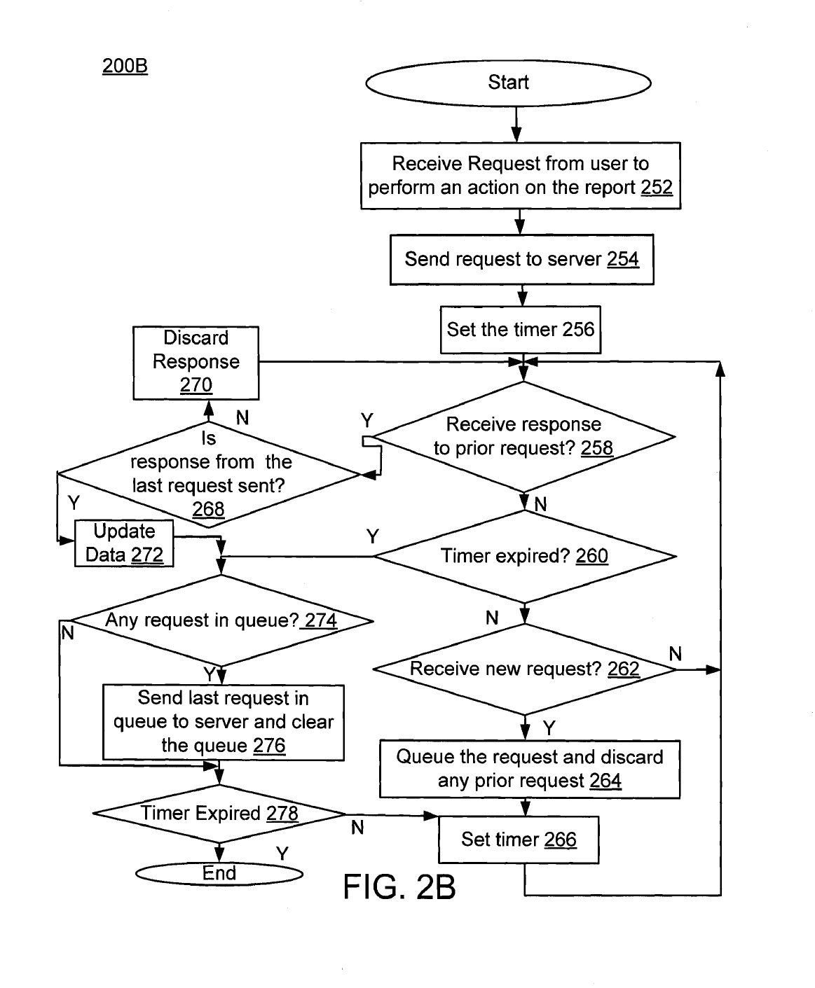

FIG. 2A shows a flowchart of an embodiment of a client-side method 200A for asynchronous interaction in the report generator in a multi-tenant database system. Method 200A may be performed by user system 114 and may be performed by a single user system or different user systems. In step 202, user system 114 may request server system 102 to perform an operation on a report from report generator 108 via network 112. The adding of a field to a report, and the removal of a field from a report are examples of operations that may be requested during step 202.

### Adding a Field to a Report

For example, during step 202, the request to add a field to a report table may be generated by the user a) dragging and dropping the field, b) double-clicking a field, c) adding groupings in summary format or d) adding a matrix grouping in matrix format.

Remove Field from a Report

For example, during step 202, the request to remove a field from a table may be generated by the user by a) dragging and dropping data, b) selecting a menu option that involves removing data, c) indicating to remove a grouping when a single grouping exists (the result of the removing operation being to leave no grouping in the report), d) the user indicating to remove a super-group from a report with multiple groupings (the result of which being leaving only the subsequent groupings), and/or e) the user indicating to remove a subgroup from a report with multiple groupings leaving only groupings (a super-group may be a group of sub-groups).

In matrix format, during step 204, the request may involve the user indicating to remove of a horizontal grouping (which may result in the displaying the report without the grouping, and removing the summaries for each value of the grouping). Similarly, the request may involve the user indicating to remove a vertical grouping (which may cause the report to be displayed without the grouping and without the summaries for each value of the vertical grouping. The removal of a horizontal/vertical super-group causes the report to be displayed with sub-grouping and without super-grouping. Similarly, the removal of a horizontal/vertical sub-grouping causes the removal of the sub-group leaving the super-groups and the subtotals).

In step 204, display algorithm 116 displays a placeholder in the position where a data may appear after the operation is performed. Display algorithm 116 may mark the add position with a place holder that shows the position for the data to be inserted. In a “hide details mode” when an aggregated field is added, a placeholder may be inserted in the locations showing the values, after the aggregations (e.g., sum, maximum, minimum, average) that should be applied to the field after the requested change is performed. In step 206, display algorithm 116 relinquishes control to the user, allowing the user system to perform other tasks. Some operations may not have asynchronous interactions with the report generator. Display algorithm 116 may perform a check to see whether the action requested is one of the actions for which asynchronous operations is available or whether the operation is not one of the operations for which asynchronous operations are available (e.g., there may be a list of operations encoded into decision statements for which asynchronous operations are available, which may be checked prior to allowing asynchronous operations). For example, in one embodiment, changing filter settings in a report requires fetching the data from multi-tenant database 104 and may not allow for asynchronous interactions of report generator 108 and user system 114. In an embodiment when a field is removed from a report with a top-n filter, the report generator may not allow user interaction until the results are returned (a top-n filter is a filter that keeps only those records in which a field has value greater than a particular value—a top-n filter retrieves the records with the top-n values). Some requests are cancelled in order to save computer resources and prevent one tenant from dominating the resources. For example, in an embodiment, when user system 114 sends a request to report generator 108 for an operation before receiving the results of previous operations, the user may only receive results of the last request (because the server will cancel all previous requests). When a user system switches to run report from preview mode, and if the result of the previous operation has not been received by the user system, display algorithm 116 sends request to cancel the outstanding request and run the report with the current report design as the target for the complete run. When multiple operations are requested by user system 114, display algorithm 116 ensures that the last results that were received from server system 102 are displayed to the user irrespective of the actions of server system 102 (and optionally the server may interpret the last request as a request to cancel previous requests). Requests may be bundled on the server-side.

In step 208, the user system receives data that may be the result of the requested operation. In step 210, display algorithm replaces the placeholder with the received data. Display algorithm 116 may refresh a portion of the report or the complete report based on the type of operation performed.

In an embodiment, each of the steps of method 200A may be a distinct step. In other embodiments, method 200A may not have all of the above steps and/or may have other steps in addition to or instead of those listed above. The steps of method 200A may be performed in another order. Subsets of the steps listed above as part of method 200A may be used to form their own method. In an embodiment, there could be multiple instances of method 200A.

### Method of Queuing Requests:

FIG. 2B shows a flowchart of an embodiment of method 200B for queuing in asynchronous interaction in the report generator in a multi-tenant database system. Method 200B may be performed by user system 114 and may be performed by a single user system or many user systems. In method 200B, when a user initiates an operation, an initial request is sent to the server, and the sending of the request to the server a rolling window (e.g. of 5 seconds) is set during which new operation are not processed. Each request may include of a full report definition. Before the rolling window expires or the results from the initial request processed and returned (whichever comes first), if the user initiates a new operation, the new operation request is queued, and the rolling window is shifted by for example being reset (thus if the window is 5 seconds, the expiration time is reset to 5 seconds). Upon the expiration of the window or upon the results of the initial request being returned (whichever comes first), only the last queued request is sent out to the server and the queue is cleared. Method 200B reduces the number of server requests result from changes to a report definition, because requests from intermediary changes are ignored, and most likely the user is only concerned with the latest report definition. A new rolling window may be initiated as a server request is in transport.

The flowchart of FIG. 2B illustrates an example of one method of achieving the desired result of method 200B. the invention is not confined the algorithm of FIG. 2B. In step 252, the user initiates a request. In step 254, the request is sent to the server, and in step 256 a time is set. In an embodiment steps 254 and 256 are performed simultaneously or performed within a negligible amount of time of one another in any order, so that from the point of view of the user both steps appear to occur simultaneously. In step 258 a determination is made as to whether a response to the request was received. If no response was received, method 200B proceeds to step 260. In step 260, a determination of whether the timer has expired is made. If the timer has not expired, method 200B proceeds to step 262. In step 262, a determination is made whether the user has made another request. If the user has not made a user request, method 200B returns to step 258, to determine whether results were received from the request most recently submitted to the server. Steps 258, 260 and 262 may be performed simultaneously, concurrently or in any order. Also, steps 258, 260, and 262 need not be performed with the same frequency.

Returning to step 262, if a new request is received from the user, method 200B proceeds to step 264. In step 264, the new request is queued. In an embodiment, any prior request that were in the queue are discarded. In step 266 the timer is reset. Steps 264 and 266 may be performed, simultaneously, concurrently, or in any order.

In an alternative embodiment, steps 252-256 are not included and instead, after one of steps after 262 and either before or after step 264 or step 266, a check can be performed as to whether there is any requests that are outstanding, whether there were any requests in the queue and whether the timer expired, and if there are no responses outstanding, no requests in queue prior to step 264 and the timer had expired prior to step 266, then a new request would be sent.

Returning the current embodiment, after step 266, method 200B returns to step 258 to determine whether results from a request have been received. Returning to the discussion of step 258, if results form a request were received, method 200B proceeds to step 268 to determine whether the received results are from the last request sent. If the results received are not from the last request sent, then method 200B proceeds to step 270, where the results received are discarded. After step 270, method 200B returns to step 258 to check whether another set of results has been received.

Returning to step 268, if the results received were from the last request were sent to the server, then method 200B proceeds to step 272, where the data displayed to the user is updated. After step 272, method 200B proceeds to step 274. Step 274 may be arrived at after performing step 272 or after performing step 260. In other words, returning to step 260, if the time has expired, method 200B proceeds to step 274. In step 274 a determination is made whether there are any requests in the queue. If there are any requests in the queue, the method proceeds to step 276, where the most recent request is sent to the server. In an embodiment, after step 276 method 200B continues to step 278.

Returning to step 274, if there are no requests in the server, method 200B continues to step 278 In step 278, a determination is made whether the timer has expired. If the timer has not expired, method 200B continues to step 266, and the timer is reset. Returning to step 278, if the timer has expired and there are no more requests in the queue, method 200B, terminates, and the next request initiated by the user restarts method 200B.

In an embodiment, if method 200B entered step 274 as a result of the timer being checked in step 260, step 278 need not be performed (for example, method 200B may perform steps 274A and 276B after step 260, while method 200B may perform steps 274A 276A and 278 after performing step 272, where steps 274A and 274B would be identical to current step 274 and steps 274A and steps 274B would only differ from one another in terms which step each one follows, and similarly steps 276A and 276B would be identical to current step 276 and would only steps 276A and 276B would differ from one another only in terms which step each one follows), and in that step 278 would follow step 276A and would not come after step 276B.

As an example, the time for response from the server is 5 s:
1. Time 0 s: User performs operation A (and for example performs step 252-256),
   a. Request is sent to server
   b. Timer expiration set to 5 s
2. Time 1 s: no user operation (and for example, method 200B loops through steps 258-262 several times)
   a. Timer expires in 4 s
3. Time 2 s: User performs operation B (and as a result in step 262, the method 200B transfer control to step 264)
   a. No request to server (the message is just queued in step 264 and the timer is reset in step 266)
   b. Timer expires at 7 s
4. Time 3 s: User performs Operation C (and as a result in step 262, the method 200B transfer control to step 264)
   a. Operation B is discarded (as part of step 264)
   b. No request to server
   c. Timer Expires at 8 s (in step 266)
5. Time 8 s: Timer expires (after possibly cycling through steps 258-262 and stopping in step 260)
   a. Operation C is sent to server (as a result of performing steps 274 and 276)
   b. Timer expiration set at 13 s (as a result of performing steps 278 and then step 266)
6. Time 9 s: User performs Operation D (from step 266 method 200B proceeds to perform step 258-262, and step 262 detects the operation)
   a. No request to server
   b. Timer expiration set at 14 s (in step 264)
7. Time 10 s: Operation C returns (which, after performing steps 266, is detected in step 258)
   a. Operation D gets sent to server (which occurs after performing steps 268 and 272)
   b. Timer expiration set at 15 s (which occurs after performing steps 274, 276, 278, and 266)
8. Time 11 s: Operation A returns (which is detected as a result of performing step 258)
   a. Operation A is not latest request sent (Operation D is) (which is determined at step 268), response gets discarded (in step 270)
   b. Timer expiration set at 15 s
9. Time 12 s: Operation D returns (which is detected in step 258)
   a. No outstanding request sent to server (which is determined in step 268), Operation D is the last request sent No timer set
   b. Results gets updated (step 272)

In an embodiment, each of the steps of method 200B may be a distinct step. In other embodiments, method 200B may not have all of the above steps and/or may have other steps in addition to or instead of those listed above. The steps of method 200B may be performed in another order. Subsets of the steps listed above as part of method 200B may be used to form their own method. In an embodiment, there could be multiple instances of method 200B.

### Server-Side Method of Providing Asynchronous Interaction in the Report Generator

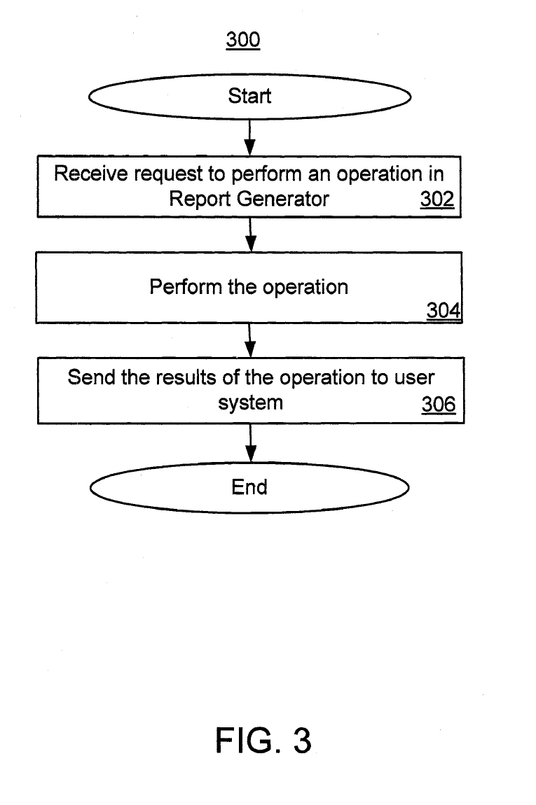

FIG. 3 shows a flowchart of an embodiment of a server-side method 300 for asynchronous interaction with report generator 108 in a multi-tenant database system. In step 302, server system 102 receives a request to perform an action on the report in the report generator from user system 114 for example server system receive signals resulting from dragging and dropping a field to add a field to a table.

In step 304 server system 102 performs the operation, via report generator 108. The operation may require report generator 108 to perform one or more queries to multi-tenant database 104. During step 304, user system 114 may perform other tasks that may not need the results of the requested operation. The user system need not wait for results of certain operation and thus report generator 108 and user system 114 may interact asynchronously. In step 306, server system 102 may send results of the operation in report generator 108 to user system 114 via network.

If the server system receives a message from the user system 114 to cancel an operation or to perform a new operation, report generator 108 stops the query to multi-tenant database 104 in order to preserve system resources. While server system 102 requests are outstanding, the actions of user system 114 that require a stable state for example save report, save report as, run report, save report format may not be allowed. While a request is outstanding, if another request is received for an action that requires a stable state, then the server may block the action requested or cancel the outstanding request, depending on the embodiment.

In an embodiment, each of the steps of method 300 may be a distinct step. In other embodiments, method 300 may not have all of the above steps and/or may have other steps in addition to or instead of those listed above. The steps of method 300 may be performed in another order. Subsets of the steps listed above as part of method 300 may be used to form their own method. In an embodiment, there could be multiple instances of method 300.

### Screenshots

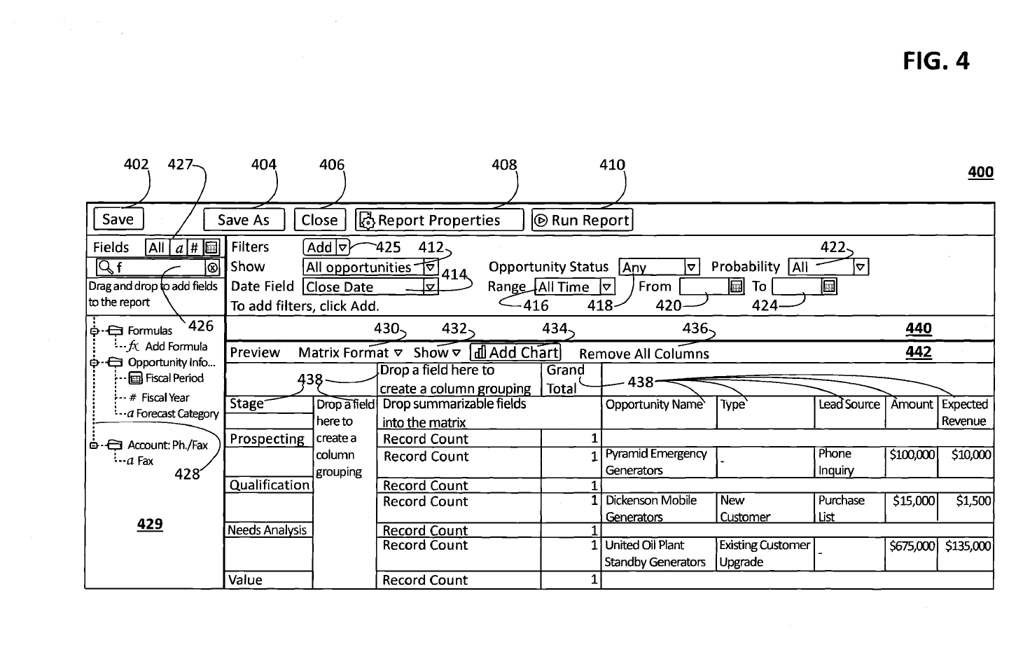

FIG. 4 shows report 400 of an embodiment of report generator. Report 400 may include save button 402, save as button 404, close button 406, report properties button 408, run report button 410, show 412, date 414, range 416, opportunity status 418, from 420, probability 422, to 424, filters 425, search 426, list fields 427, field list 428, fields pane 429, matrix 430, show 432, add chart 434, remove 436, fields in preview 438, filter pane 440, and preview pane 442. In other embodiments, report 400 may not have all of the elements listed and/or may have other elements instead of or in addition to those listed.

Report 400 is a screenshot of a report from report generator showing an ‘opportunities’ report with ‘opportunities’ report type. Save button 402 when selected pops up a window with requesting report name and report unique name and the report folder to save the report. Save as button 404 when selected pops up a window requesting a new name to save the report. Close button 406 when selected closes the report. Report properties button 408 when selected displays the properties of the report. Run report 410 when selected runs the report which is previewed in the preview pane. Show 412 when selected lists the data related to the report type for the user, team's or all user's data. Example in report 400, show 412 when selected ‘my opportunities’, ‘my team's opportunities’ or ‘all opportunities’. Date 414 when selected lists the date options for a report. For example in report 400, when date 414 is selected, date of last activity, report created date, last modified date may be displayed. Range 416 when selected lists the option for date ranges for a report. For example the date range may be all time, specific dates, fiscal year, fiscal quarter etc. Opportunity status 418 when selected lists the status of records in the report. Status may be any, open, closed (indicating that the opportunity no longer exists), or closed won (indicating that the opportunity no longer exists because the sale was made). From 420 is the selection of the first date for the data range in the reports. Probability 422 when selected lists the probability (as a percentage) that is associated with an opportunity (e.g., the probability that the opportunity will become a sale). To 424 is the selection of the last date of a date range for reports. Filters 425 when selected lists a menu of the filters available for reports. Search 426 is an input box to search for data or fields in the report. The fields may be added or removed from the report. Search 426 is a quick find input box, the search narrows down the list of available fields based on the user entering the first few letters of the field. List fields 427 shows the options available for displaying fields, all fields, alphabetical order, fields starting with ‘#’ or date fields. Field list 428 shows the list of fields. In report 400, list 428 shows fields starting with the letter T. Fields can be dragged and dropped to add to the report for preview. Fields pane 429 is the fields panes consisting of quick find input box 426, list fields 427, and field list 428. Matrix 430 is the report format of the current report. Reports are available in tabular format, summary and matrix formats. Show 432 when selected shows the details in the report. Show 432 toggles with hide option. Add chart 434 when selected adds a chart to the report. Remove 436 when selected removes all columns in the report. Fields in preview 438 shows the fields in the current report on report 400. Filter pane 440 is the filter pane with options to set filters for a report. Filters may be the date filter, or type of report field or opportunity status. Preview pane 442 is the pane for previewing a report before creating a report. The preview pane shows the report for a small data set so that the same report can be edited before finally running the report.

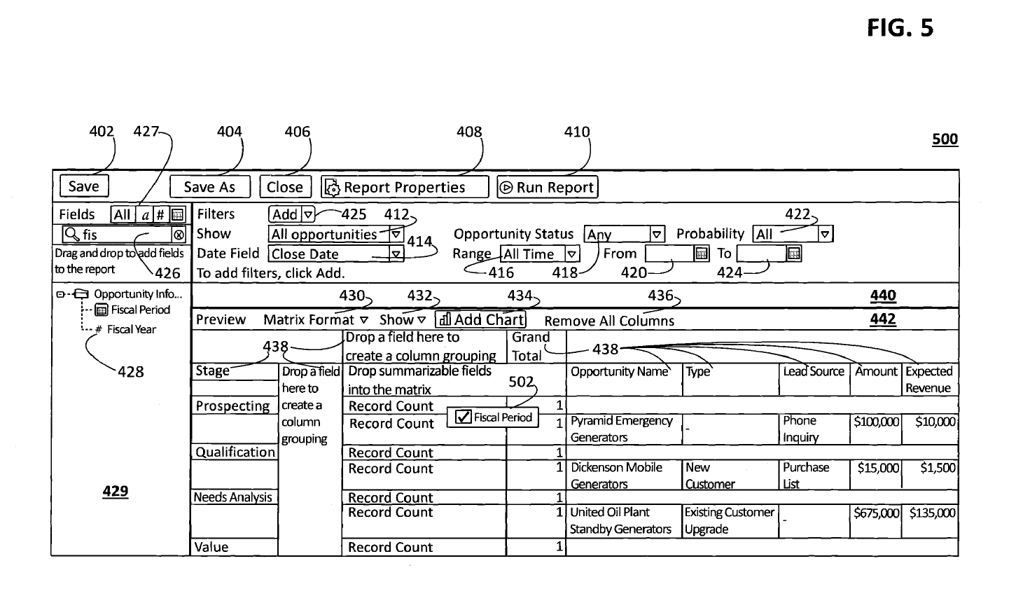

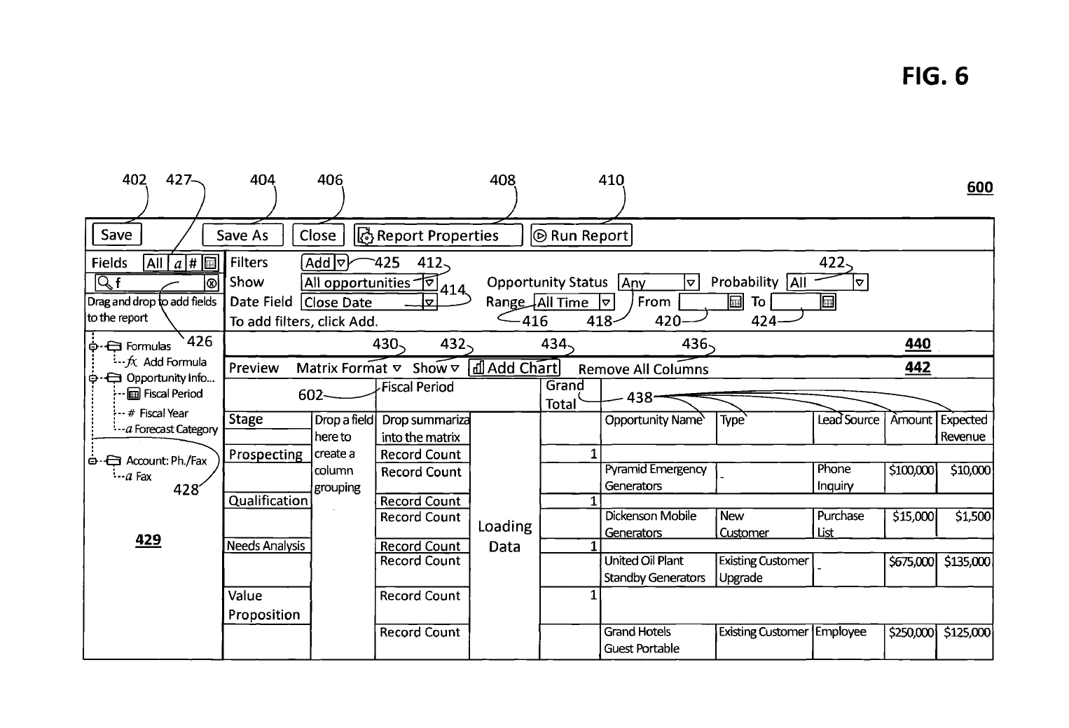

Although save button 402, save as button 404, close button 406, report properties button 408, run report button 410, show 412, date 414, range 416, opportunity status 418, from 420, probability 422, to 424, filters 425, search 426, list fields 427, field list 428, fields pane 429, matrix 430, show 432, add chart 434, remove 436, fields in preview 438, filter pane 440, and preview pane 442 appears in the screenshots of each of FIG. 4, FIG. 5, and FIG. 6, since the description of save button 402, save as button 404, close button 406, report properties button 408, run report button 410, show 412, date 414, range 416, opportunity status 418, from 420, probability 422, to 424, filters 425, search 426, list fields 427, field list 428, fields pane 429, matrix 430, show 432, add chart 434, remove 436, fields in preview 438, filter pane 440, and preview pane 442, was discussed above, that description will not be repeated in FIG. 5, and FIG. 6.

FIG. 5 shows dragging-field report 500 of an embodiment of report where a field is being dragged into the preview pane. Dragging-field report 500 may include save button 402, save as button 404, close button 406, report properties button 408, run report button 410, show 412, date 414, range 416, opportunity status 418, from 420, probability 422, to 424, filters 425, search 426, list fields 427, field list 428, fields pane 429, matrix 430, show 432, add chart 434, remove 436, fields in preview 438, filter pane 440, preview pane 442 and dragged field 502. In other embodiments, dragging-field report 500 may not have all of the elements listed and/or may have other elements instead of or in addition to those listed.

Dragging-field report 500 shows a field is being dragged into the preview pane. Dragged-field 502 is a field dragged from the fields pane 429 into the preview pane 442. After the field is dropped into the preview pane, display algorithm 116 inserts a place holder for the field and allows the user to continue to work on the report while the report generator access' multi-tenant database 104 to fetch the necessary data to add the field fiscal period.

FIG. 6 shows added-field 600 of an embodiment of a report where a field is added into the preview pane, but the data has not been loaded yet. Added-field report 600 may include save button 402, save as button 404, close button 406, report properties button 408, run report button 410, show 412, date 414, range 416, opportunity status 418, from 420, probability 422, to 424, filters 425, search 426, list fields 427, field list 428, fields pane 429, matrix 430, show 432, add chart 434, remove 436, fields in preview 438, filter pane 440, preview pane 442 and added field 602. In other embodiments, added-field report 600 may not have all of the elements listed and/or may have other elements instead of or in addition to those listed.

Added-field report 600 shows a field being added into the preview pane, which has not loaded, yet. Added-field 602 is a field dragged and dropped from fields pane 429 into preview pane 442. After the field is dropped into the preview pane, display algorithm 116 replaces the place holder with the data from the report generator and renders the page. Added-field report 600 shows the field ‘Fiscal Period’ added to the report; however, the since the data is not available, yet, the column where the data currently is blank and just include the legend “loading.”

### System Overview

FIG. 7 illustrates a block diagram of an environment 710 wherein an on-demand database service might be used. Environment 710 may include user systems 712, network 714, system 716, processor system 717, application platform 718, network interface 720, tenant data storage 722, system data storage 724, program code 726, and process space 728. In other embodiments, environment 710 may not have all of the components listed and/or may have other elements instead of, or in addition to, those listed above.

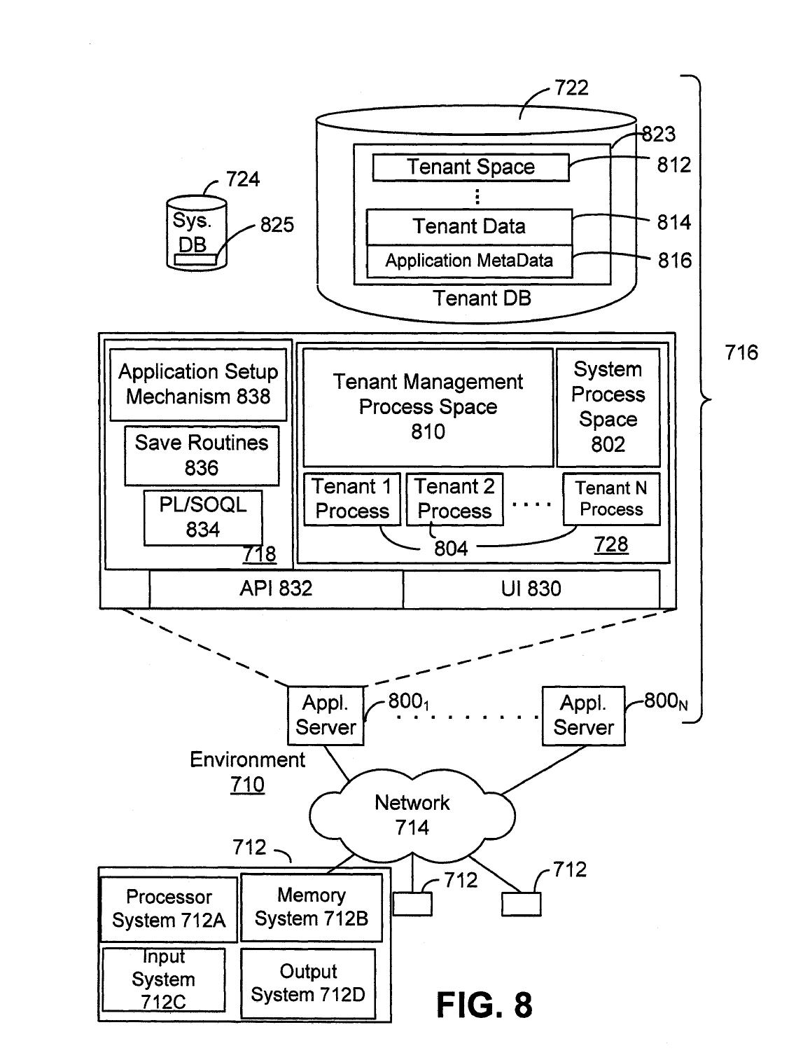

Environment 710 is an environment in which an on-demand database service exists. User system 712 may be any machine or system that is used by a user to access a database user system. For example, any of user systems 712 can be a handheld computing device, a mobile phone, a laptop computer, a work station, and/or a network of computing devices. As illustrated in FIG. 7 (and in more detail in FIG. 8) user systems 712 might interact via a network 714 with an on-demand database service, which is system 716.

An on-demand database service, such as system 716, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 716” and “system 716” will be used interchangeably herein. A database image may include one or more database objects. A relational database management system (RDMS) or the equivalent may execute storage and retrieval of information against the database object(s). Application platform 718 may be a framework that allows the applications of system 716 to run, such as the hardware and/or software, e.g., the operating system. In an embodiment, on-demand database service 716 may include an application platform 718 that enables creation, managing and executing one or more applications developed by the provider of the on-demand database service, users accessing the on-demand database service via user systems 712, or third party application developers accessing the on-demand database service via user systems 712.

The users of user systems 712 may differ in their respective capacities, and the capacity of a particular user system 712 might be entirely determined by permissions (permission levels) for the current user. For example, where a salesperson is using a particular user system 712 to interact with system 716, that user system has the capacities allotted to that salesperson. However, while an administrator is using that user system to interact with system 716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 714 is any network or combination of networks of devices that communicate with one another. For example, network 714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 712 might communicate with system 716 using TCP/IP and, at a higher network level, use other common Internet protocols to communicate, such as HTTP, FTP, AFS, WAP, etc. In an example where HTTP is used, user system 712 might include an HTTP client commonly referred to as a “browser” for sending and receiving HTTP messages to and from an HTTP server at system 716. Such an HTTP server might be implemented as the sole network interface between system 716 and network 714, but other techniques might be used as well or instead. In some implementations, the interface between system 716 and network 714 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 716, shown in FIG. 7, implements a web-based customer relationship management (CRM) system. For example, in one embodiment, system 716 includes application servers configured to implement and execute CRM software applications as well as provide related data, code, forms, webpages and other information to and from user systems 712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 716 implements applications other than, or in addition to, a CRM application. For example, system 716 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 716.

One arrangement for elements of system 716 is shown in FIG. 7, including a network interface 720, application platform 718, tenant data storage 722 for tenant data 823, system data storage 724 for system data 825 accessible to system 716 and possibly multiple tenants, program code 726 for implementing various functions of system 716, and a process space 728 for executing MTS system processes and tenant-specific processes, such as running applications as part of an application hosting service. Additional processes that may execute on system 716 include database indexing processes.

Several elements in the system shown in FIG. 7 include conventional, well-known elements that are explained only briefly here. For example, each user system 712 could include a desktop personal computer, workstation, laptop, PDA, cell phone, or any wireless access protocol (WAP) enabled device or any other computing device capable of interfacing directly or indirectly to the Internet or other network connection. User system 712 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 712 to access, process and view information, pages and applications available to it from system 716 over network 714. Each user system 712 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 716 or other systems or servers. For example, the user interface device can be used to access data and applications hosted by system 716, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 712 and all of its components are operator configurable using applications, such as a browser, including computer code run using a central processing unit such as an Intel Pentium® processor or the like. Similarly, system 716 (and additional instances of an MTS, where more than one is present) and all of their components might be operator configurable using application(s) including computer code to run using a central processing unit such as processor system 717, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 716 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 716 is configured to provide webpages, forms, applications, data and media content to user (client) systems 712 to support the access by user systems 712 as tenants of system 716. As such, system 716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 8 also illustrates environment 710. However, in FIG. 8 elements of system 716 and various interconnections in an embodiment are further illustrated. FIG. 8 shows that user system 712 may include processor system 712A, memory system 712B, input system 712C, and output system 712D. FIG. 7 shows network 714 and system 716. FIG. 8 also shows that system 716 may include tenant data storage 722, tenant data 823, system data storage 724, system data 825, User Interface (UI) 830, Application Program Interface (API) 832, PL/SOQL 834, save routines 836, application setup mechanism 838, applications servers 8001-800N, system process space 702, tenant process spaces 704, tenant management process space 710, tenant storage area 712, user storage 714, and application metadata 716. In other embodiments, environment 710 may not have the same elements as those listed above and/or may have other elements instead of, or in addition to, those listed above.

User system 712, network 714, system 716, tenant data storage 722, and system data storage 724 were discussed above in FIG. 7. Regarding user system 712, processor system 712A may be any combination of one or more processors. Memory system 712B may be any combination of one or more memory devices, short term, and/or long term memory. Input system 712C may be any combination of input devices, such as one or more keyboards, mice, trackballs, scanners, cameras, and/or interfaces to networks. Output system 712D may be any combination of output devices, such as one or more monitors, printers, and/or interfaces to networks. As shown by FIG. 7, system 716 may include a network interface 720 (of FIG. 7) implemented as a set of HTTP application servers 800, an application platform 718, tenant data storage 722, and system data storage 724. Also shown is system process space 702, including individual tenant process spaces 704 and a tenant management process space 710. Each application server 800 may be configured to tenant data storage 722 and the tenant data 823 therein, and system data storage 724 and the system data 825 therein to serve requests of user systems 712. The tenant data 823 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 830 provides a user interface and an API 832 provides an application programmer interface to system 716 resident processes to users and/or developers at user systems 712. The tenant data and the system data may be stored in various databases, such as one or more Oracle™ databases.

Application platform 718 includes an application setup mechanism 838 that supports application developers' creation and management of applications, which may be saved as metadata into tenant data storage 722 by save routines 836 for execution by subscribers as one or more tenant process spaces 704 managed by tenant management process 710 for example. Invocations to such applications may be coded using PL/SOQL 834 that provides a programming language style interface extension to API 832. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 716 for the subscriber making the invocation and executing the metadata as an application in a virtual machine.

Each application server 800 may be communicably coupled to database systems, e.g., having access to system data 825 and tenant data 823, via a different network connection. For example, one application server 800i might be coupled via the network 714 (e.g., the Internet), another application server 800N-1 might be coupled via a direct network link, and another application server 800N might be coupled by yet a different network connection. Transfer Control Protocol and Internet Protocol (TCP/IP) are typical protocols for communicating between application servers 800 and the database system. However, it will be apparent to one skilled in the art that other transport protocols may be used to optimize the system depending on the network interconnect used.

In certain embodiments, each application server 800 is configured to handle requests for any user associated with any organization that is a tenant. Because it is desirable to be able to add and remove application servers from the server pool at any time for any reason, there is preferably no server affinity for a user and/or organization to a specific application server 800. In one embodiment, therefore, an interface system implementing a load balancing function (e.g., an F5 Big-IP load balancer) is communicably coupled between the application servers 800 and the user systems 712 to distribute requests to the application servers 800. In one embodiment, the load balancer uses a least connections algorithm to route user requests to the application servers 800. Other examples of load balancing algorithms, such as round robin and observed response time, also can be used. For example, in certain embodiments, three consecutive requests from the same user could hit three different application servers 800, and three requests from different users could hit the same application server 800. In this manner, system 716 is multi-tenant, wherein system 716 handles storage of, and access to, different objects, data and applications across disparate users and organizations.

As an example of storage, one tenant might be a company that employs a salesforce where each salesperson uses system 716 to manage their sales process. Thus, a user might maintain contact data, leads data, customer follow-up data, performance data, goals and progress data, etc., all applicable to that user's personal sales process (e.g., in tenant data storage 722). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 716 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 716 might also maintain system level data usable by multiple tenants or other data. Such system level data might include industry reports, news, postings, and the like that are sharable among tenants.

In certain embodiments, user systems 712 (which may be client systems) communicate with application servers 800 to request and update system-level and tenant-level data from system 716 that may require sending one or more queries to tenant data storage 722 and/or system data storage 724. System 716 (e.g., an application server 800 in system 716) automatically generates one or more SQL statements (e.g., one or more SQL queries) that are designed to access the desired information. System data storage 724 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### Method for Using the Environment (FIGS. 7 and 8)

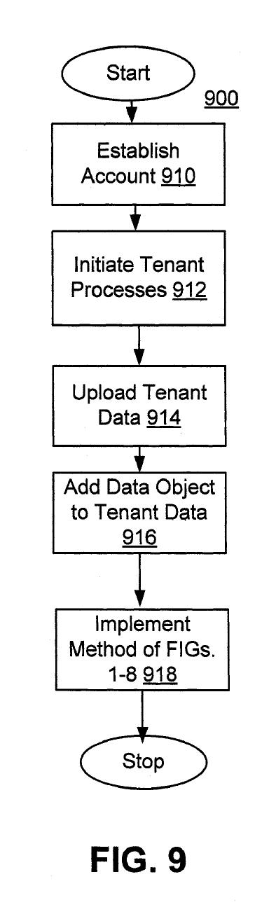

FIG. 9 shows a flowchart of an example of a method 900 of using environment 710. In step 910, user system 712 (FIGS. 7 and 8) establishes an account. In step 912, one or more tenant process space 804 (FIG. 8) are initiated on behalf of user system 712, which may also involve setting aside space in tenant space 812 (FIG. 8) and tenant data 814 (FIG. 8) for user system 712. Step 912 may also involve modifying application metadata to accommodate user system 712. In step 914, user system 712 uploads data. In step 916, one or more data objects are added to tenant data 814 where the data uploaded is stored. In step 918, the methods associated with FIGS. 7-8 may be implemented. In another embodiment, although depicted as distinct steps in FIG. 9, steps 902-918 may not be distinct steps. In other embodiments, method 900 may not have all of the above steps and/or may have other steps in addition to, or instead of, those listed above. The steps of method 900 may be performed in another order. Subsets of the steps listed above as part of method 900 may be used to form their own method.

### Method for Creating the Environment (FIGS. 7 and 8)

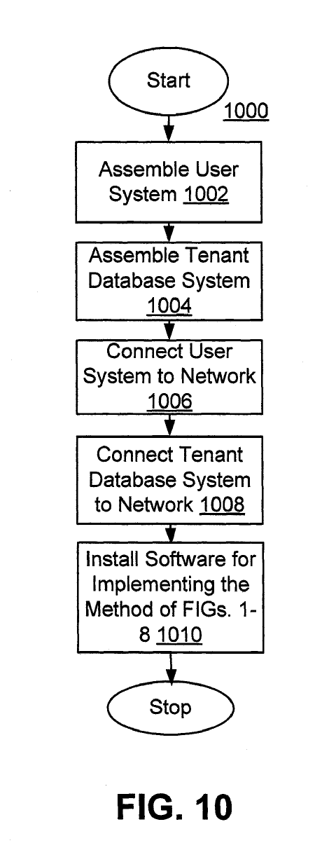

FIG. 10 is a method of making environment 710, in step 1002, user system 712 (FIGS. 7 and 8) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another.

In step 1004, system 716 (FIGS. 7 and 8) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another. Additionally assembling system 716 may include installing application platform 718, network interface 720, tenant data storage 722, system data storage 724, system data 825, program code 726, process space 728, UI 830, API 832, PL/SOQL 834, save routine 836, application setup mechanism 838, applications servers 100₁-100_{N}, system process space 102, tenant process spaces 804, tenant management process space 110, tenant space 812, tenant data 814, and application metadata 816 (FIG. 8).

In step 1006, user system 712 is communicatively coupled to network 804. In step 1008, system 716 is communicatively coupled to network 804 allowing user system 712 and system 716 to communicate with one another (FIG. 8). In step 1010, one or more instructions may be installed in system 716 (e.g., the instructions may be installed on one or more machine readable media, such as computer readable media, therein) and/or system 716 is otherwise configured for performing the steps of methods associated with FIGS. 7-8. In an embodiment, each of the steps of method 1000 is a distinct step. In another embodiment, although depicted as distinct steps in FIG. 10, steps 1002-1010 may not be distinct steps. In other embodiments, method 1000 may not have all of the above steps and/or may have other steps in addition to, or instead of, those listed above. The steps of method 1000 may be performed in another order. Subsets of the steps listed above as part of method 1000 may be used to form their own method.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

### EXTENSIONS AND ALTERNATIVES

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1-18. (canceled)

19. A non-transitory computer-readable medium having computer instructions stored thereon that are capable of causing operations comprising:
receiving, by a computing device via a user interface, a first request to perform a first operation associated with a particular portion of the user interface;
sending, by the computing device, the first request to a server system to retrieve data to perform the first operation;
causing, by the computing device, display of an indication that data responsive to the first operation is being loaded from the server system;
receiving, by the computing device, a second user request to perform a second operation associated with a different portion of the user interface;
sending, by the computing device, the second request to the server system in response to determining that second operation is permitted while the first operation is pending; and
subsequent to retrieving the data responsive to the first operation, the computing device causing display of results associated with the first operation in the particular portion of the user interface.

20. The non-transitory computer-readable medium of claim 19, wherein the operations further comprise:
preventing one or more other user requests while displaying the indication and waiting for the response to the first request, in response to determining that the one or more other requests request to access data associated with the particular portion.

21. The non-transitory computer-readable medium of claim 20,
wherein the user interface is a report interface; and
wherein the one or more other requests include at least one of: a request to save a report, a request to rename the report, a request to run the report, or a request to format the report.

22. The non-transitory computer-readable medium of claim 19, wherein the determining that second operation is permitted while the first operation is pending includes determining that the second operation does not request to access data associated with the particular portion.

23. The non-transitory computer-readable medium of claim 19, wherein the server system is a multi-tenant database system that is accessible to retrieve results for display via the user interface.

24. The non-transitory computer-readable medium of claim 19, wherein the second request corresponds to a different portion of the user interface than the first request.

25. The non-transitory computer-readable medium of claim 19, wherein the operations further comprise queuing the second request for a predetermined time interval prior to sending the second request to the server system.

26. The non-transitory computer-readable medium of claim 19, wherein the user interface is a tabular interface that includes an ordered set of rows and columns.

27. The non-transitory computer-readable medium of claim 26, wherein the first request is a request to update a column of the user interface.

28. The non-transitory computer-readable medium of claim 19, wherein the user interface includes a preview pane for a report generator.

29. A method, comprising:
receiving, by a computing device via a user interface, a first request to perform a first operation associated with a particular portion of the user interface;
sending, by the computing device, the first request to a server system to retrieve data to perform the first operation;
causing, by the computing device, display of an indication that data responsive to the first operation is being loaded from the server system;
receiving, by the computing device, a second user request to perform a second operation associated with a different portion of the user interface;
sending, by the computing device, the second request to the server system in response to determining that second operation is permitted while the first operation is pending; and
subsequent to retrieving the data responsive to the first operation, causing display of results associated with the first operation in the particular portion of the user interface.

30. The method of claim 29, further comprising:
preventing one or more other user requests while displaying the indication and waiting for the response to the first request, in response to determining that the one or more other requests request to access data associated with the particular portion.

31. The method of claim 30, wherein the one or more other requests are requests to access data associated with the first request.

32. The method of claim 30, wherein the one or more other requests include at least one of: a request to save a report, a request to rename the report, a request to run the report, or a request to format the report.

33. The method of claim 29, wherein the determining that second operation is permitted while the first operation is pending includes determining that the second operation does not request to access data associated with the particular portion.

34. The method of claim 29, wherein the server system is a multi-tenant database system.

35. An apparatus, comprising:
one or more processors; and
one or more memories having program instructions stored thereon that are executable by the one or more processors to:
receive, via a user interface, a first request to perform a first operation associated with a particular portion of the user interface;
send the first request to a server system to retrieve data to perform the first operation;
cause display of an indication that data responsive to the first operation is being loaded from the server system;
receive a second user request to perform a second operation associated with a different portion of the user interface;
send the second request to the server system in response to determining that second operation is permitted while the first operation is pending; and
subsequent to retrieving the data responsive to the first operation, cause display of results associated with the first operation in the particular portion of the user interface.

36. The apparatus of claim 35, wherein the instructions are further executable to:
prevent one or more other user requests while displaying the indication and waiting for the response to the first request, in response to determining that the one or more other requests are not permitted while the first operation is pending.

37. The apparatus of claim 35, wherein the instructions are further executable to:
prevent one or more other user requests while displaying the indication and waiting for the response to the first request, in response to determining that the one or more other requests request to access data associated with the first request.

38. The apparatus of claim 35, wherein the server system is a multi-tenant database system that is accessible to retrieve results for display via the user interface.
